(19) United States
(12) Patent Application Publication
(10) Pub. No.: US 2002/0066034 A1
(43) Pub. Date: May 30, 2002

(54) Distributed network security deception system

(76) Inventors: Barry J. Schlossberg, Tampa, FL (US); Wenbiao Wang, Tampa, FL (US)

Correspondence Address: William T. Ellis, FOLEY & LARDNER, Washington Harbour, 3000 K Street, N.W., Suite 500, Washington, DC, 20007-5109, US

(21) Appl. No.: 09/956,942

(22) Filed: Sep. 21, 2001

Related U.S. Application Data
(60) Provisional application No. 60/242,675, filed on Oct. 24, 2000.

(51) Int. Cl. G06F 11/30

(52) U.S. Cl. 713/201

(57) ABSTRACT

A computer-network security system and method including the steps of providing a deception to a network intruder on the computer-network, monitoring a response of the network intruder to the deception, detecting the network intruder based upon the response of the network intruder to the deception, collecting data regarding the network intruder; and acting on the data regarding the network intruder to protect the computer-network. This system includes a deception unit, an interception unit, a detection unit, a notification unit, a receiving unit, a database unit, a watching unit and a management unit. Also disclosed are deception methods for protecting a network, and a graphical display system which permits operators to rapidly assess an attack and take corrective action.

### CROSS-REFERENCE TO RELATED APPLICATION(S)

This application claims the benefit of priority under 35 U.S.C. §119(e) of provisional application serial number 60/242,675 entitled “A Deception Management Based Network Security Inspection System,” filed on Oct. 24, 2000, the disclosure of which is incorporated herein in its entirety.

### FIELD OF THE INVENTION

The present invention relates generally to the field of computer-network security systems, and more particularly to a computer-network security management system employing deception as one of a number of methods with internal and external components vectored by management consoles and reports for protecting a computer-network against network intruders.

### BACKGROUND OF THE INVENTION

In the physical world, deterring a potential intruder or assailant is easier than it is in the computer world. A posted sign stating that there is a security watch in the area, or a security system is usually enough to protect a house or a store from most illegal activity. In the world of computers, this is far from the truth.

Potential intruders of a computer network are not warned as easily. When an attacker reaches a computer within a network that has not been deliberately configured for web or sharing purposes, that person's actions are likely to be considered deliberate rather than accidental in nature.

Although it is not practical to rely on warning messages as a first line of defense, they can be of value. Especially if a case of computer misuse goes to a court of law, because failure to warn intruders that unauthorized access is punishable by law can negate a competent prosecution effort.

The need for security is advancing in parallel with the advancement of computer and network technology. Security measures have been increased due to the rise of computer hackers and the need to prevent the curious from obtaining files and accessing networks that are meant to be private.

As cited in U.S. Pat. No. 6,070,244, with society's increasing dependence on information systems, the risk of misuse or sabotage of those systems has grown to be a significant problem. Making the problem more real are the daily news stories of hackers breaking into computers, and computers being infected with viruses. Adding to the risk is the rise in the number of corporate mergers and acquisitions, which has resulted in large numbers of both new system users and potentially disgruntled displaced workers.

Many large scale companies have intricate and complicated security schemes that contain loopholes and cannot be supervised and managed regularly. This leaves their information systems open to those who are able to intrude into the system. Generally, hackers get into systems without being caught because the large-scale designs of the security system are inadequate.

Computer network attacks can take many forms and can include different types of security attacks. Security protects the computer systems against such attacks including the stealing of confidential files or information, and producing network damaging mechanisms, such as viruses. Of course, a first level of protection is the requirement to enter a personal password to access the network, but this is a very simple method of protection to work around, especially in light of the advanced computer knowledge possessed by a modem day computer hacker.

As cited in U.S. Pat. No.6,108,786, firewalls have been used to protect the private intranet by filtering traffic to and from the Internet. The firewall provides a single check point where network traffic can be audited. In general, a firewall is a gate-keeping computer that is connected between the Internet and the internal private Intranet. Packet filtering firewalls are typically implemented in routers. Proxy based application gateway firewalls run programs that secure information flowing through a gateway.

Current security systems are limited in their ability to detect or deny access to assailants who are highly skilled in overcoming simple deception methods. Therefore, it is a general object of the invention to alleviate the problems and shortcomings identified above.

### SUMMARY OF THE INVENTION

The present invention implements and manages a deception environment to provide security on a computer network. This deception environment simulates a real computer network with deception units working together to deceive, distract, deflect, derail, detect and intercept a network intruder's activities, thereby protecting the computer network.

In one aspect, the present invention provides a method for providing security on a computer-network, including the steps of providing a deception environment to a network intruder on the computer-network, monitoring a response of the network intruder to the deception environment, detecting the network intruder based upon the response of the network intruder to the deception environment, collecting data regarding the network intruder, and acting on the data regarding the network intruder to protect the computer-network. In one embodiment, the computer-network is connected to a public network, and the deception environment is accessible via the public network.

Another aspect of the present invention provides a method for detecting an intruder on a computer-network with access to a public network including the steps of deceiving the intruder regarding the function, designation or data contents of a deception unit within the deception environment, gathering data on the intruder as the intruder attempts to access the function, designation or data contents of the deception unit, and outputting the data on the intruder to a receiving unit.

A further aspect of the present invention is a method for protecting a computer-network once an intruder has been detected, including the steps of deceiving the intruder regarding the function, designation or data contents of a deception unit within the deception environment, permitting the intruder to access the deceptive function, designation or data contents of the deception unit; and gathering data on the intruder as the intruder accesses the deceptive function, designation or data contents of the deception unit.

A further aspect of the present invention is a system for protecting a computer-network connected to a public network from network intruders, including a management unit, a sub-network connected to the management unit but separate from the protected computer-network and configured to communicate commands and data to and from the management unit, a deception unit coupled to the management unit by the sub-network and accessible from the public network, an interception unit coupled to the computer-network and coupled to the management unit by the sub-network, a database management unit coupled to the protected computer-network and configured to store data regarding network intruders, a receiver unit coupled to the management unit by the sub-network and configured to receive data from any one or all of the deception unit, interception unit, and notification unit, and communicate received data to the database management unit for storage, and a reconnaissance unit coupled to the public network outside the computer-network and coupled to the management unit by the sub-network.

Another aspect of the present invention is a security system for protecting a computer-network connected to a public network from intruders, including a means for deceiving intruders as to the function, designation or content of a machine and providing an output of information regarding intruders' interactions with the means for deceiving, the means for deceiving being coupled to the computer-network and accessible by the public network, a means for detecting intruders based upon information provided in the output of the means for deceiving intruders, the means for detecting intruders being coupled to the computer network and configured to provide an output of data regarding detected intruders, a means for receiving the output of data regarding detected intruders provided by the means for detecting intruders, a means for storing data coupled to the means for receiving the output of data regarding detected intruders, and a means for managing the security system coupled to each of the means for deceiving intruders, detecting intruders, receiving the output of data and storing data.

In yet another aspect of the present invention, a computer readable data storage medium has program code recorded thereon for the automated detection of a network intruder on a computer-network connected to a public network, with the program code including a first program code that masquerades as a device or network function which the network intruder is likely to seek out, detects the network intruder by monitoring attempts to access the masqueraded device or network function, gathers information on the network intruder and outputs the information on the network intruder, a second program code that receives the outputted information on the network intruder, and acts upon the outputted information on the network intruder by issuing commands to protect the computer-network, and a third program code that receives and executes the commands from the second program code.

Another aspect of the present invention is a system for providing security on a computer-network that includes a management component for managing the system, a deception component coupled to the management unit and to the computer network for deceiving network intruders and providing an output comprising data on actions taken by the network intruder, the deception component being, a receiving component coupled to the deception component and the management component for receiving the output from the deception component and providing an output of data, and a data collection component for receiving the data output from the receiving component, storing data and providing stored data to the receiving component and/or the management component, the data collection component being coupled to the receiving unit and to the management component.

### BRIEF DESCRIPTION OF THE DRAWINGS

FIG. 1 is a schematic diagram illustrating the major components of the present invention.

FIG. 2 is a schematic diagram illustrating an Alert and Response scenario.

FIG. 3 is a schematic diagram illustrating how Checks and Balances work.

FIG. 4 is a schematic diagram illustrating a formula to describe threat level at any given time.

FIG. 5 is a schematic diagram illustrating the Boolean logic employed in the system to provide fast evaluation on the network intruder's activities.

FIG. 6 is a schematic diagram illustrating the protocol employed in the system to provide secure communication among all system components.

### DETAILED DESCRIPTION OF THE PREFERRED EMBODIMENTS

The following is a description of the design and the implementation of a computer network security system utilizing deception that is implemented in a computer network in accordance with the present invention. This system uses deception within a deception environment to inspect, detect and protect network security.

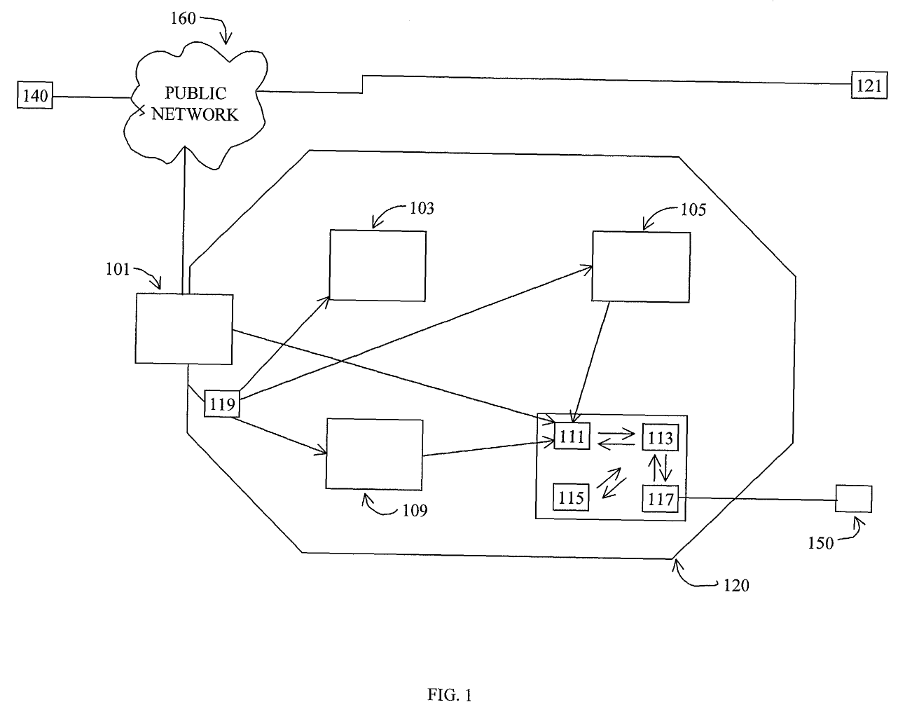

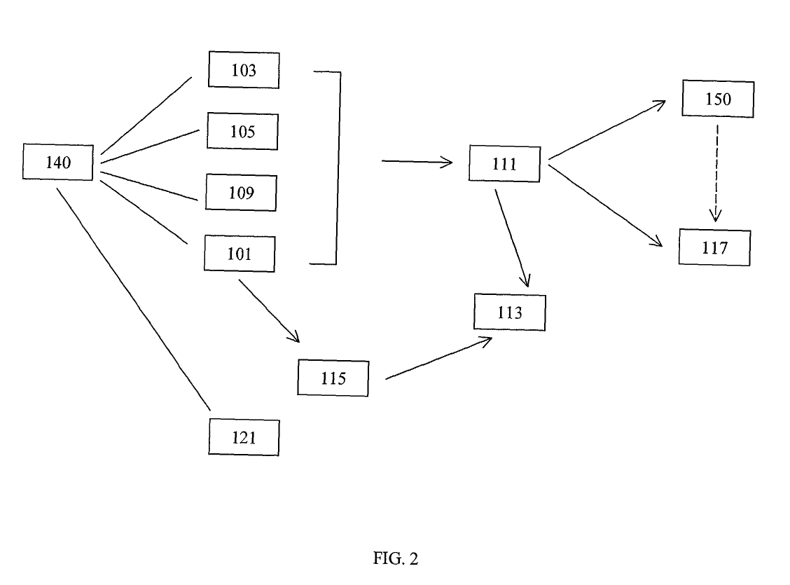

Referring now to FIG. 1, a protected network 120, serviced by an NTP time server 119, includes various segments or elements 101-121 that are used to make up the whole unit. The various segments may include a deception unit 101, 105, an interception unit 103, a notification unit 109, a receiving unit 111, a database management server (DBMS) 113, a watching unit 115, a management unit 117, and a reconnaissance unit 121. This system employs up to five different measures or methods of computer deception, accomplished in deception units, to protect the network. If set up correctly, deceptive measures can derail attackers' efforts, causing them to focus on and reach the wrong systems. This takes the pressure off of the most valuable computers and spreads the first line of defense by giving security personnel ample time to react.

A deception unit 101, 103, 105, 109 is a computer connected to the network to be protected and operating software that causes it to display attributes or respond to communications from an intruder so as to mislead the intruder regarding the true identity of the computer or of the files stored on the computer by employing one or more of the following five deception methods. As explained more fully herein, depending upon the method of deception deployed on a deception unit and the configuration of the network security system, a deception unit may serve as a notification unit 109, an interception unit 103, or a detection unit 105.

The first method of deception used in this system is heightened visibility, provided by what is called a “flag machine” deception unit. This method is applied to a computer in ways such as causing it to indicate share or web access availability within a network. This provides deception at the simplest level. This method may be used in the network to develop a psychological profile of the network visitor. For example, the information provided to security personnel on the intruder includes who the visitor is, the declared purpose for the visitor's access, how determined the access effort is, the hours when this activity occurred and so forth. Skillful security investigators can then draw upon available information to discover identities and infer possible motives and methods of an unauthorized activity. A flag machine deception unit may be created in one embodiment by providing it with a prominent domain name associated with the network to be protected which responds to queries by communicating a web page indicating that various information, servers or links may be accessed through this machine. In another embodiment, the flag machine deception unit displays banners on web pages that explicitly state that an unauthorized access to this system is a federal crime and violators will be prosecuted. In these various embodiments, the machine responds to queries by providing heightened visibility to attract potential intruders.

The second method of deception used in this system is baiting, provided by what is called a “vending machine” deception unit. A “vending machine” is a computer that has been configured to appear as a machine of value to an intruder. In one embodiment of this system, the machine may be designated with an attractive machine name, IP address or hyperlink that would attract the attention of a criminal. For example, the machine may be named “payroll” or “creditcard_db” In another embodiment, the vending machine deception unit may store worthless or dummy data files with attractive file names implying potentially valuable information. For example, the machine may contain a file labeled “passwords.mdb” that lists inactive passwords. Other examples of attractive file names include “creditcard.mdb” and “payroll.xls.” In yet another embodiment of this system, the vending machine may be a machine set up with a known weakness to intruders. For example, a vending machine may be created by setting up a Microsoft IIS server without the software patch that is supposed to fix or prevent the “Code Red” worm. By setting such “baits” and tempting an unauthorized intruder to attempt to access such obviously sensitive files, the “vending machine” misdirects the intruder's efforts enabling network security to be alerted and respond without risking loss of confidential information. Furthermore, attempts to access such a “bait” or vending machine may be presumed to be an indication of an attack worth reporting to the network administrator.

The third method of deception used in this system is masquerading, provided by what is called a “chameleon machine” deception unit. This is a method that takes advantage of known elements in an environment to enhance deception. This machine appears to a network intruder to be the same or identical to an existing machine that must be protected. In one embodiment of this system, the chameleon machine deception unit is given the address, name or a data file of another machine that is necessarily part of the network to be protected. For example, in a network for a financial institution, the chameleon machine might be named “customer account numbers” and contain fake but authentic-looking account numbers. In another embodiment of this system, a chameleon machine may be created by running software that causes it to appear as though it will run or offer an attractive and well-known service that is the same as a service running inside of an organization. For example, the chameleon machine may be a web server machine running a duplicate of a company's web site with banners, key words or other features that attempt to attract an intruder's attention. As a further example, the chameleon machine may be set up as a human resources information system inside of the company, such as running PeopleSoft software, that simulates the real human resources information system running in the company, but in a manner designed to attract an intruder's attention.

The fourth method of deception used in this system is invisibility, provided by what is called a “black hole machine” deception unit. The main characteristic of this machine is that it is not visible on the network, but is still receptive to inbound data. The data obtained by this machine may reveal the behavior of an unauthorized intruder, such as errant network data or data from network probing activity. In one embodiment of this system, a black hole machine is created by permitting the machine to monitor network communications but providing the machine with no IP address so it does not “appear” to an intruder attempting to access the network. Without an IP address, the machine will not respond to an Address Resolution Protocol (ARP) request. Setting up a machine in this manner permits the machine to monitor the activities of the entire network and scan for disallowed network activities without being easily detected by an intruder.

The fifth method of deception used in this system is a moving target, provided by what is called a “mobile machine” deception unit. A mobile machine can be reconfigured or, in some cases, can reconfigure itself to avoid being identified by an intruder. Reconfiguration is accomplished via two primary elements; network address shifting, and service shifting. Network address shifting means being able to logically move to different locations within a network. Service shifting means changing the services that are active and hence what is visible to the inhabitants of a network. In one embodiment of this system, a mobile machine deception unit is provided by permitting the machine to randomly select an IP address from a pool of IP addresses. Shifting from one IP address to another makes it very difficult for an intruder to identify the deception units in a network, which increases the effectiveness of the deception units in defeating a determined attacker. In another embodiment of this system, a mobile machine deception unit may be provided by shifting between the type of network service software running on the machine, such as randomly selecting service software to operate from a pool of service software. For example, a mobile machine deception unit may run human resources services software, such as PeopleSoft, for a period of time and the switch to running a database services software, such as Oracle database software. Shifting among service software operating on a deception unit makes it more difficult for an intruder to identify the deception units in a network, which increases the effectiveness of the deception units in defeating a determined attacker. In yet another embodiment of this system, a mobile machine deception unit may be provided by shifting from one simulated virtual network to another simulated virtual network. For example, the mobile machine deception unit may simulate a human resources department network for some time and then shift to simulating an engineering department network. Shifting among different simulated virtual networks provided on a deception unit makes it more difficult for an intruder to identify the deception units and the simulated virtual networks, which increases the effectiveness of the deception units in defeating a determined attacker.

A preferred embodiment of the present system uses a complete deception management system that incorporates one or more of the five methods of deception discussed above. This embodiment of the invention may use all five of these methods and incorporate them into a single package, making all of the deception, surveillance, data storage and system management capabilities part of one highly configurable system. This system may be configured for operation on a single broadcast network, a switched network, or may be distributed on a heterogeneous network spanning multiple subnets.

The deception units 101, 103, 105, 109 employing one or more of the five deception methods described herein, are the core of the present network security solution. Deception units may be installed on a network perimeter or internal subnet to provide a different approach to confuse and deceive the attacker. The deception units run off read-only media to prevent any writing attempt by an attacker and they also re-boots themselves when the units have been compromised by an attacker for a pre-set period of time.

Besides the deception units, the present network security system may also include a receiving unit 111, a DBMS unit 113, a watching unit 115, a management unit 117, and a reconnaissance unit 121, all of which utilize, analyze, store, display and take action upon the information gathered by the various deception units 101, 103, 105, 109.

A receiving unit is a machine configured to receive communications from deception units and to relay those communications to the DBMS unit 113 and management unit 117. All suspicious data detected by deception units are reported to the receiving unit including information on the possible source and destination IP.

A DBMS unit 113 is a machine that stores data on suspicious network activities and makes that data available to the network security system and to operators. It may be a simple database server or a dedicated computer with internal or external data storage capability.

A management unit 117 is a machine that coordinates the overall activities of the network security system and each of the components. It may direct the deception activities of the various deception units, command or control security responses of the network, notify network managers of threats or protective actions, provide information on network threat levels to network managers and it may receive commands from network managers.

A watching unit 115 is a machine configured to present information to network managers regarding network security threat levels, current attacks, past attacks and other data generated by the network system. As more fully described herein, this unit may include a visual display with graphics to present security information in a useful format for network managers.

A reconnaissance unit 121 is a machine configured to investigate attackers using information on the attacker obtained by the network security system and the resources available on the Internet. For example, if the network security system obtains the IP address of the attacker, this address could be passed to the reconnaissance unit 121 which could then obtain information on the attacker via publicly accessible databases.

A preferred embodiment of the present system accomplishes the functions of detection, protection, reaction, reconnaissance, and command center capabilities.

Detection involves gathering data and categorization used to establish pertinent security activity within a network. Each deception unit machine in the system collects data from network traffic which is analyzed statistically. Using Boolean logic this data is filtered and prioritized. Once each deception unit has processed the network traffic data, the resulting information is transmitted to the DBMS 113 data repository via the receiving unit 111.

Protection is the ability to remotely command machines within the network in a state of heightened security threat to enter a state of hardening, deflection, or shut down. Hardening protection is accomplished by changing the state of available ports and services, thus blocking access. This type of protection induces deflection and shutdown practices. Deflection protection utilizes port re-direction by causing a machine to re-route rather than block incoming traffic. Attackers are deceived into believing they have connected to the machine, when in actuality, they have been connected to a different machine. Shutdown protection is accomplished by a validated remote shutdown command issued from the management console. Shutdown is the most extreme method of protection.

Reaction is the ability of the security system automatically respond to threat inputs. In a preferred embodiment, the system constantly reports the current threat levels, which is explained more fully herein. When a preset threat threshold is crossed, a reaction system reacts to preserve the integrity of the system it is protecting.

Reconnaissance is the process by which external data on attackers are retrieved for intelligence purposes. Many pieces of information that may substantially help in identifying an adversary can be obtained from public databases and other sources openly available on the Internet.

Command center functions provide the user interface through which the security system is viewed and controlled by network managers. Configuration and administration of all users and system elements, network and computer status reports, alerts, data mining, and reconnaissance are all done via secured communications between the command center, its users, and its elements.

Returning to FIG. 1, the functionality and interactions of the major components of a preferred embodiment of the present system may include one or more of the following: a deception unit 101, a notification unit 109, an interception unit 103, a detection unit 105, a reconnaissance unit 121, a watching unit 115, a database management (DBMS) unit 113, a system management unit 117, and a receiving unit 111. Each of these system units is described more fully below.

The Deception Unit 101 shown in FIG. 1 may be configured as a “Flag”, “Vending”, or “Chameleon” deception unit “placed” on the perimeter of the network for viewing by the external world or on the internal subnet meant to confuse the attacker 140. A Deception Unit 101 may be “placed” on the perimeter of a network by connecting it to a network's “DMZ” (de-militarized zone) (i.e., outside of security firewalls) and giving it an IP address or a web domain name that makes it easily accessible via the Internet. Depending on the chosen strategy, the machine may also be configured as a “Mobile Machine”, with the full range of configurable options that a Deception Unit 101 can perform, as well as how it interacts with the Watching Unit 115. All suspicious data are reported to the Receiving Unit 111 with possible source and destination IP.

The Notification Unit 109 shown in FIG. 1 is a “Vending” or “Black Hole” machine residing on a live server. It is configured to “watch” its own activities, or additionally to watch the traffic of the entire subnet. The Notification Unit 109 “watches” its own or network activities by running a program in the background that monitors key stroke entries or network communications, compares the key stroke entries or network communications to a list of potentially suspicious entries or communications stored in memory, and, when there is a match between the detected key stroke or network communication and the list of suspicious activities, stores, analyzes or acts on the information. By way of example, but not by way of limitation, the software may monitor the entire file system integrity and key stroke entries to detect attempts to read, copy, or modify protected files stored on the machine containing information of such sensitivity, such as files containing network user passwords, that such attempts are necessarily suspicious. Similarly, network communication indicating an attempt to access a protected server (e.g., the human resources network server) or data file (e.g., a file of valid passwords) would be determined to be suspicious. Thus, the Notification Unit 109 acts as an agent, reporting suspicious activities for internal security auditing purposes. All suspicious data are reported to Receiving Unit 111 along with the possible source and destination IP address data.

The Interception Unit 103 shown in FIG. 1 may be a “Flag”, “Vending”, “Chameleon”, or “Black Hole” machine. It may not be a “Mobile Machine”. An Interception Unit 103 is an implementation of “deflection protection,” it must therefore remain in a fixed location for interception of data from another source such as source routing on a firewall. By “fixed location” it is meant that the IP address of the Interception Unit 103 must not change while the security system is operating. Thus, the unit is always at the same network address location every time the attacker searches the network or attempts to access the machine. The Interception Unit 103 is usually installed on a broadcast network segment or switched network segment to report any disallowed network activities. All suspicious activities data are reported to the Receiving Unit 111 with possible source and destination IP. By way of example but not by way of limitation, suspicious activities may include attempts to access a particular file, machine or server, attempts to flood the network with communications (e.g., “pings”) so as to deny service, attempts to gain control of a machine, server or network, or communications from a particular IP address. Further by way of example, suspicious activities may also include disallowed activities, which are activities for which the actor does not have the proper authorization, such as an attempt to access a limited-access file for which the actor does not have the proper authorization. In this example, a double click on a file icon representing a limited-access file by a person without the proper authorization would be identified as a suspicious activity, and the data associated with this suspicious action (e.g., accessing machine, action, actor and time of day) would be reported to the Receiving Unit 111.

The Detection Unit 105 shown in FIG. 1 is a “Black Hole” machine. It is connected to the network and configured to receive and monitor network communications, and report only for the network segment it is attached to. The Detection Unit 105 operates similar to the Interception Unit 103. However, this unit does not have an assigned IP address. Therefore, it is almost impossible for an intruder to detect it using network probing methods. This makes it an ideal tool for portable or plug-in network segment monitoring. It is also installed usually on a broadcast network segment or switched network segment to report any disallowed network activities. These activities may occur on any machines connected on this segment of the network. All suspicious data are reported to the Receiving Unit 111 with possible source and destination IP.

The receiving unit 111 shown in FIG. 1 receives reported findings from each of the aforementioned “Units”. The receiving unit is the data collector among all other units in the network security system. Suspicious activity data sent from the various sensor reporting units (e.g., deception units 101, notification units 109, interception units 103, and detection units 105) is parsed into different threat levels and resulting data is stored in a physical device, such as a data storage unit, which is managed by the DBMS Unit 113, for later analysis. The different threat levels and a mechanism for parsing suspicious activity data among different threat levels is more fully disclosed below. The Receiving Unit 111 has the added capacity to interpolate data obtained from each of the reporting units and store the interpolated data in the DBMS Unit 113. The Receiving Unit 111 also has the capacity to establish threat level thresholds that may restrict the flow of data to the DBMS 113 to prevent data overload. Since this unit has immediate data access, pre-configured threat levels may be used to trigger a notification to the on-duty security personnel through various means, including but not limited to electronic mail messages, alarms, on-screen displays, pager messages, telephone calls and two-way radio broadcasts activated by the receiving unit 111.

The primary function of the Reconnaissance Unit 121 shown in FIG. 1 is to identify attackers and assist in determining their capabilities. This unit accomplishes this function through a set of software-implemented security tools accessible by system security personnel through the Management Unit 117. By way of example but not by way of limitation, such security tools may include software that will use Internet protocol routines to identify the attacker's machine operating system, discover the attacker's machine network service venerability, locate the attacker's machine network (such as what is the machine DNS name and who is the internet upstream provider), and determine the geographical location of the attacker's connection to the Internet (i.e., where the DNS server is physically located and how the intruder is connected to the internet). These tools permit security personnel to acquire information on the attacker 140 by accessing public databases, record information on the network and/or Internet service provider used by the attacker, gather information on the attacker's machine unique operating system characteristics (operating system “finger printing”), scan the attacker's machine network service port, query the attacker's machine DNS (a “who is” query), and trace the attacker's machine routing. The Reconnaissance Unit 121 is usually connected to the Internet outside of the protected network, but it can also be installed inside of the protected network, accessing the Internet via the network's Internet access server. The reason for typically installing the Reconnaissance Unit 121 outside of the network being protected is to permit the unit to obtain information and identify the attacker 140 and his/her capabilities without the attacker 140 knowing this information is being gathered by the network he/she is attacking. The Reconnaissance Unit 117 notifies the owner of the security system and generates a detailed report to the network security personnel with information, such as the MAC/IP address attacker 140 is using, the attacker's machine DNS name, the attacker's physical location, and other pertinent information. By using the same set of tools, the Reconnaissance Unit 121 is also useful in assessing internal and external network weaknesses.

The purpose of the Watching Unit 115 shown in FIG. 1 is to allow security management to view live data streams from any of the reporting units at will. The Watching Unit 115 receives network security data from one or more of the DBMS unit 113, the Management Unit 117, the Reconnaissance Unit 121 and the Receiving Unit 111. The Watching Unit 115 provides graphic displays on a computer monitor and/or on print outs of pertinent security information, including but not limited to suspicious activities detected by the system, the current overall threat level facing the system, the past and/or real-time activities of an attacker (e.g., attempts to access a particular file or server), faults or points of vulnerability in the network, and information gathered on a particular attacker by the Reconnaissance Unit 121. By transforming the data gathered by the security system into graphics that can be rapidly comprehended by system security personnel, the Watching Unit 115 improves the overall effectiveness of the security system by facilitating timely and effective operator intervention to appropriately respond to a particular threat or to conduct an investigation into an attack while it is occurring. An embodiment of one such graphical representation of threat data is more fully described below. This functionality is highly useful when an attack is in progress; it allows security management to watch a perpetrator's actions in real time. This capability allows security management to take immediate action when a breach in security has occurred.

The DBMS Unit 113 shown in FIG. 1 is a database for the system. The DBMS Unit 113 is one or more data recording devices, such as disk drives, tape drives, compact disk (CD) recorders, controlled by an database interface to the system hosted on a computer connected to the network security system. The DBMS Unit 113 may also include a data backup system, such as a CD recorder, that creates a permanent record of data generated by the security system. This backup recording maybe is made at intervals to assure data integrity, to obtain an accurate record of reported activity, and to thwart data tampering.

The Management Unit 117 shown in FIG. 1 is the center of command. The Management Unit 117 provides a single console with an easy-to-use interface to manage the entire system. The Management Unit 117 is programmed to perform the functions of system deployment, system modification, security personnel task assignment, stored data analysis, system operation monitoring, and other pertinent functions. In a preferred embodiment, all deception management control originates in the Management Unit 117, and such control are carried out via a security protocol, such as the secure communications protocol embodiment described in more detail below. For security purposes, once a security system user is connected to the Management Unit 117, a user login is validated and permissions specific to that particular user are granted. This permits the network owner to limit the access and control granted to particular network security personnel to those which they need to perform their roles. For example, security system operators on the night-shift may be provided access to data from sensor units and control over network responses (e.g., the ability shutdown parts or all of the network, or disconnect the network from the Internet), but not access to information gathered by the Reconnaissance Unit 121 or historical data stored on the DBMS Unit 113 which may be limited to security investigators and management. By way of example but not by way of limitation, the Management Unit 117 may operate by displaying a series of web pages each containing information and links to execute various system commands or to display web pages presenting different security-related information and/or control options. Administrative functions, reconnaissance, alerts, status reports, DBMS searches and controls are all incorporated into the user interface of the Management Unit 117.

The connections among the various elements of the present security system illustrated in FIG. 1 may be understood by an example of how the system responds to an attack. By way of example but not by way of limitation, when an attacker 140 attempts to intrude the network, the attempt is detected by a sensor unit, namely one or more of the Deception Unit 101, the Notification Unit 109, the Interception Unit 103 or the Detection Unit 105, which detects the attack, for example, as an attempt to access a file, machine or server without proper Authorization. The unit sensing the attack sends data on the attempt to the Receving Unit 111 which sends the data on to the DBMS Unit 113 for storage and to the Management Unit 117 for action. Upon detecting the attack, the system responds by presenting a type of deception to the attacker 140. Once this mode of deception, selected from the five types of deception described more fully herein, has been implemented, the reaction of the attacker 140 to the deception is monitored and detected by the system. Specifically, the unit or units implementing the selected deception collect data on the intruder and the intruder's activities. Each sensor unit compares individual network activities data it collects to a Boolean logic table which correlates particular activities to pre-selected threat indices or threat responses. Based upon the particular match of an activity to the Boolean logic table, the sensor unit may report the activity data to the Receiving Unit 111. The Receiving Unit 111 also compares the activity data to a Boolean logic table to determine what additional action must be taken. If the activity match to the Boolean table indicates that some action should be taken to protect the computer network, the Management Unit 117 is sent an encrypted message via the network notifying it of the need to take an action. The management unit then issues the appropriate commands to selected network security units. Such response actions may include shutting down part or all of the computer network, informing an operator of the presence of the network intruder via a message, directing a Reconnaissance Unit 121 on the public web to gather information on the network intruder, storing the data regarding the network intruder in a computer database controlled by the DBMS unit 113 for later analysis, and/or displaying for an operator the network intruder's actions on a Watching Unit 115.

The computer network can be connected to a public network 160, and that is also where the deception may be accessed by an attacker attempting to penetrate the network. Deception units on the network connected to the public network 160 may include machines executing software so they emulate (i.e., appear to an outsider accessing the machine via the network to behave as if they were) network routers, firewalls, Virtual Private Network (VPN) gateways, and switches. Deception units posing as network servers may execute software that causes them to simulate or emulate a DNS server, an Intrusion Detection Systems, and Remote Access Servers.

Now, an example of the alert and response functionality of this security system will be described, with reference to FIG. 2. Alert and response is one of the missions of the present security system. When a security event by the attacker 140 is sensed by a sensor unit, the event is reported to the Receiving Unit 111. The Receiving Unit 111 logs the received activity data to the DBMS unit 113, and sends an encrypted message to the Management Unit 117. The Management Unit 117 sends alert messages to the Security Management Personnel 150. Messages are sent to Personnel 150 using one or more of electronic mail, paging and cell phone notification, and audible and visible alerts at the workstation. Finally, the Security Management Personnel 150 takes action. When the Personnel 150 is alerted to a network threat situation, he/she must establish a connection to the Management Unit 117 if one is not already established, such as by dialing into the network or accessing the unit via a network terminal. The Personnel 150 can issue a command through the Management Unit 117 to direct security data to the Watching Unit 115 for analysis or to block the attacker's connection, such as by disconnecting from the public network the Internet server through which the attacker is accessing the private network. The Personnel 150 can also have the Management Unit 117 activate reconnaissance on the attacker's computer and its resident network through the Reconnaissance Unit 121. First, by looking at displays of security information provided on the Watching Unit 115 by the Management Unit 117, the nature and severity of the situation can be evaluated. Depending on these characteristics, Personnel 150 decides whether immediate protective action or reconnaissance is appropriate. The Management Unit 117 will also provide reports to the Personnel 150 of any automatic actions it has already taken in response to the situation.

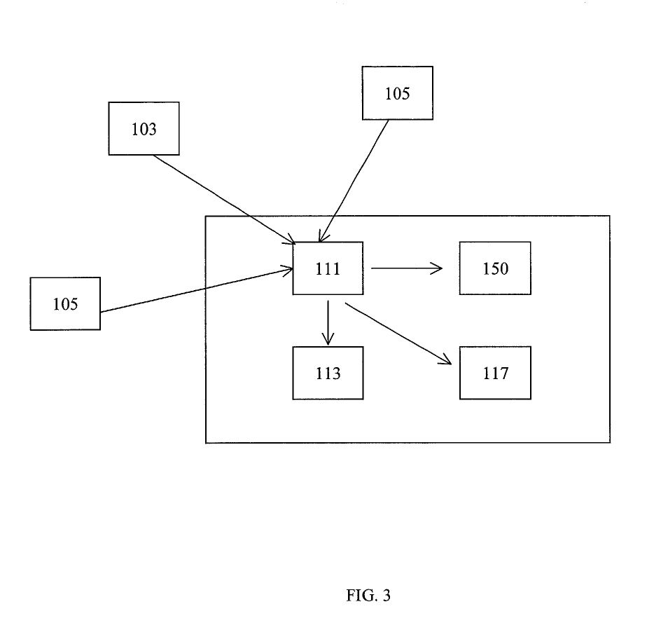

The present system also has a system of Checks and Balances which are illustrated in FIG. 3. The Network Management Personnel reports network problems to the Security Management Personnel 150. The Security Management Personnel 150 can check the operational status of network segments by searching the security system database via the DBMS unit 113 for anomalous activities that might have caused the reported network problems, and report their findings to Network Management Personnel. The present system is well suited to aid in solving network problems. The Interception Unit 103 or Detection Units 105 can be installed on all sub-networks, which are networks of users and servers connected to the main protected network, in the protected network to monitor the traffic on the entire sub-network. These units are constantly polled by the Management Unit 117. Therefore, any network anomaly can be instantly detected, sent to the Receiving Unit 111, forwarded on to security management personnel, and resolved. Such reports can be configured by the Management Unit 117 to instantly notify the Network Security Personnel 150, such as by sending alphanumeric messages to beepers or by displaying a message on the security personnel's terminal.

On occasion, something goes wrong in a network. The present system is well-suited to aid in solving network problems. Because the security units are distributed throughout the network, the units themselves can be polled for status from the Management Unit 117. If a unit proves to be unreachable or anomalous activity occurs, such information may be valuable in solving network problems quickly. This security system monitors network activity as part of its security observation system. When a machine changes its network address, the system detects the change by keying off the MAC address and comparing IP addresses. Changing IP addresses is sometimes expected, sometimes part of a criminal act, and sometimes the result of an error. In the case of network errors, a single machine can be responsible for bringing down an important network server when a user erroneously changes a computer's network configuration.

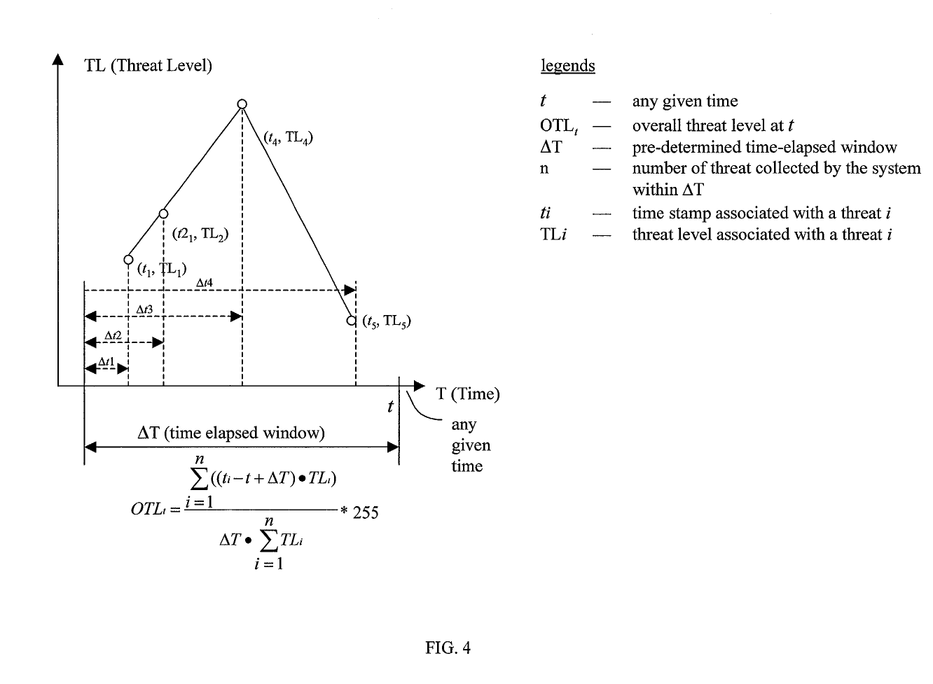

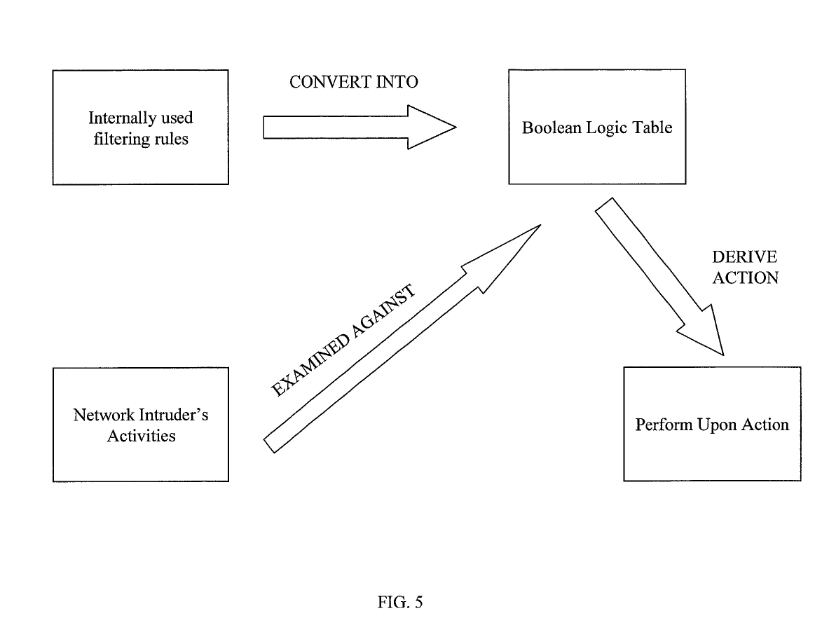

Referring to FIG. 4, the system employs Boolean Logic to rapidly sift through data obtained by the various sensing unit to accurately determine a level of threat of attack facing a system and to trigger appropriate protection functions. Since isolated and low-level “attacks” may represent little more than an incorrect IP address entries by innocent parties, it makes sense to avoid sounding an alarm every time a sensor unit detects an unauthorized network activity. However, a concerted effort represented by frequent and persistent attacks is evidence of a determined attack that may require an appropriate security response, up to and including shutting the system down it the level of threat (frequency and threat level of individual attacks) is sufficiently high. The present system is capable of assessing the overall level of threat with a Boolean Logic algorithm performed by the receiving unit using time and a relative indication of the threat posed by individual attacks. This Boolean logic evaluation mechanism tracks the threat level of individual intruder activities, the timing of individual actions and the number of actions within a given time period to determine the overall threat level (OTL) according to formula provided below. In this algorithm, a typical intruder's activities are broken into multiple network communication (TCP/IP) layers of entries, each activity is rated and time coded, and each activity is converted into or assigned Boolean values. The algorithm uses these Boolean values to yield the overall actual threat level, wherein a response can be determined accordingly.

$${OTL}_{t} = 255 * [ \frac{{\sum }_{i = 1}^{n} ( ( {t}_{i} - t + Δ T ) \cdot {TL}_{i} )}{Δ T \cdot {\sum }_{i = 1}^{n} {TL}_{i}} ]$$

Where:

t=any given time

OTLₜ=Overall Threat Level at t

ΔT=pre-determined time-elapsed window

n=number of threats collected by the system within ΔT

ti=time stamp associated with a threat I

TLᵢ=threat level associated with a threat i

As shown in FIG. 4, activities at times t1, t2 and t4, occurring over a short period of time correspond to a rising level of overall threat as calculated by the Boolean logic algorithm. However, if subsequent activities occur less frequently, the overall threat level is assessed as declining, as shown at point (t5, TL5). Thus, this algorithm is able to accurately identify and assess real threats in a network operational environment in which threat-like events may happen randomly. This Boolean Logic algorithm described above may be accomplished in any of the sensor units and/or in the Receiving Unit 111.

As illustrated in FIG. 5, a set of filtering rules is prepared to rate the threat level of different types of particular activities, TCP/IP informations or threats. These filtering rules may reflect the types of systems and information on the internal network, the perceived threats from external intruders and the level of security desired by the system administers. These filters rules are stored in a Boolean logic table which is used to examine each detected activity and assign a specific threat level. Then these individual threat levels are processed in a threat-weighted, time-averaging algorithm to determine an overall threat level at particular time. Preferably, the threat-weighted, time-averaging algorithm implements the Boolean Logic algorithm discussed above to determine the overall threat posed by a potential intruder. This overall threat level is then used by the system to determine what actions should be taken in response.

Included among the various actions that may be taken in response to a rising overall threat level is establishing a virtual, non-existent network to attract via deception and monitor the attacker activities. Such a virtual network would include virtual routers and host machines so as to appear to an attacker as if it comprises the normal units of an actual network. By establishing such a virtual network, an attacker may be drawn away from a real network that requires security and the attacker's actions can then be monitored without danger of losing data or risking damage to the real network. Given the memory and computing resources required to establish a virtual network for deception purposes, this action may only be appropriate when the overall threat level is determined to be high.

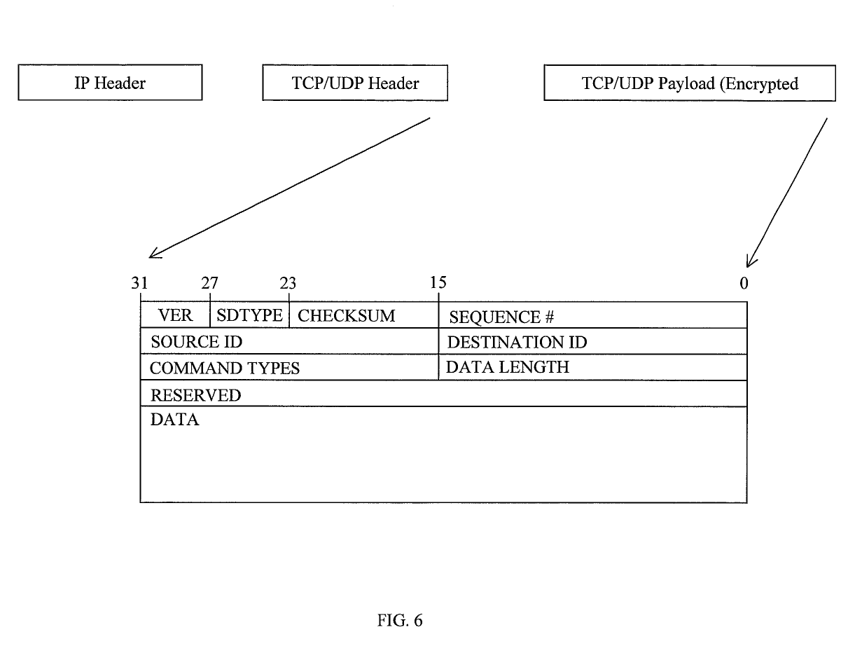

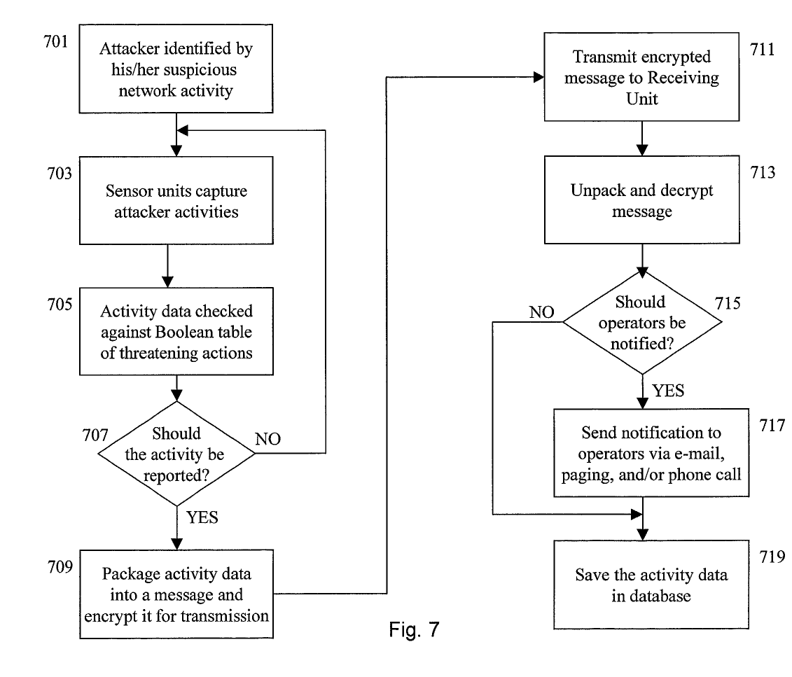

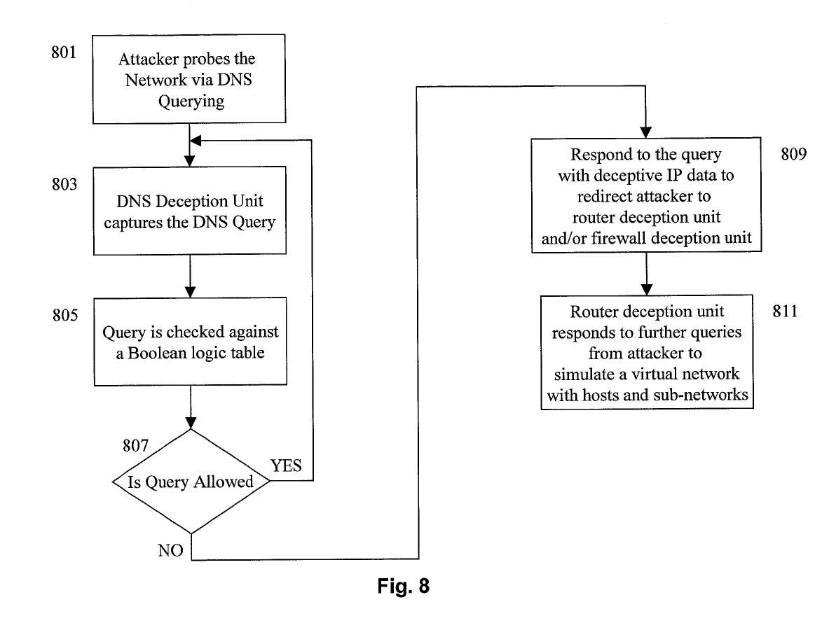

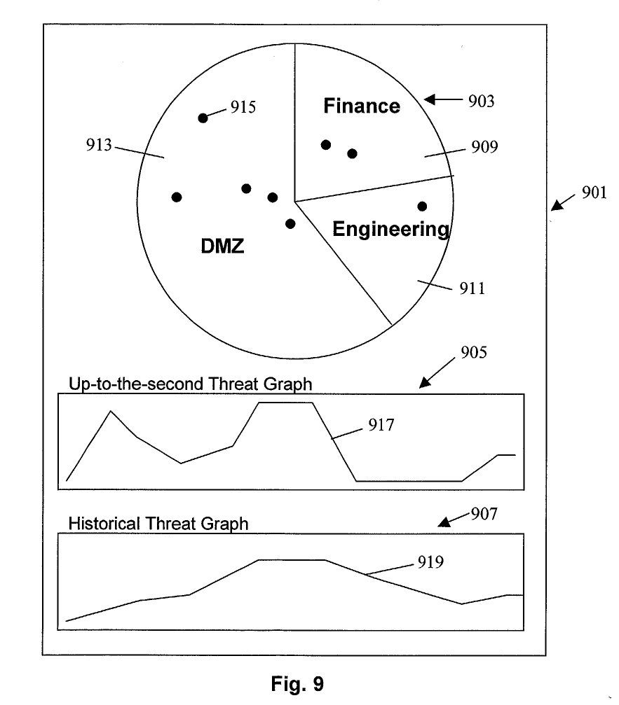

Referring to FIG. 6, the various units of the present security system communicate security related data using an encrypted data protocol. This encrypted data protocol permits the system to communicate security-related data, such as reports of attacks and commands to take protective actions, using the same network. This reduces or obviates the need for a second security-specific network and permits quick installation of additional security units (e.g., deception units or flag machines). Nevertheless, the security system may also implement a sub-network for communicating security data and protection instructions among the various units of the security system.

In a further embodiment of the present system, a graphical display of the relative threat level facing the network is provided for operator viewing such as on a watching unit. In this embodiment, the network security system generates a visual display of an intruder's activities by translating the attack activities data collected by sensor units and transmitted via the receiving unit into a graphical form that communicates the information more readily to an operator. Such a visual display may facilitate the interaction between the network security operator and the network intruder the operator is seeking to defeat. Such a graphical display of intruder's activities may combine either or both of the current, that is up-to-the-second, activities and/or historical activities collected over a period of time.

In a further embodiment, the visual display shows the intruder's activities as if they were indicia, or “blips” on a radar screen, with the blips positioned in different sectors of the radar screen corresponding to the different network segments (sub-networks) on which each the deception unit is installed. Referring to FIG. 9, The visual display 901 may consist of a radar screen display 903, an up-to-the-second system threat graphic 905 and a time-averaged historical threat graph 907. Within the radar screen graphic 903, the various sub-networks may be indicated as sectors of the radar screen 903, such as a Finance sub-network sector, 909, an Engineering sub-network sector 911 and a DMZ (sub-network outside of the security firewall) sector 913. Intruder activities are indicated as “blips” 915 which are displayed within the appropriate sector and a distance from the center of the radar screen 903. The closer the blips 915 move to the center of the radar screen 903, the more severe the intruder's attack is determined to be. The radar screen display embodiment provides the network security operator with a direct and easy to understand view of the attack situation facing the network at any given time, showing when, what and where the attack is happening. This radar screen display embodiment may further assist the network security operator to initiate a quick response to an attempted intrusion from either external or internal to the organization. The operator may use the radar screen display to closely monitor the attack, report to other network security operators what is happening, and/or shutdown network devices under attack. The network security operator can view individual network segments by selecting a particular segment or select a “close-up” view of the intruder's activities by “zooming” into a selected network segment.

In a further embodiment, the visual display of the intruder's activities provides for direct interactions between the network security operator and the network intruder. This interaction can be a simple observation, where the network security operator observes and records the intruder's activities and otherwise researches the intruder's activities. This interaction may also be a dialog between network security operator and the intruder, where the operator may have a direct “conversation” with the intruder, such as to warn the intruder about a disallowed access attempt. This direct conversation may take the form of the operator impersonating another intruder and attempting to befriend the real intruder while simultaneously taking actions to secure or protect the network and gain information about the real intruder.

In a further embodiment, the visual display of the intruder's activities includes a graphical display of each intruder's up-to-the-second activities 905 as well as the intruder's activity history over a period of time 907. Referring to FIG. 9, an up-to-the-second graphic 917 shows the immediate threat at each moment of time 917, which enables the network security operator to do an immediate damage assessment. The up-to-the-second threat graph 917 gives a clear view of the intruder's activities, which may assist operators to determine what the intruder did, when and where the intruder did it on particular network devices, and the severity of the threat posed by the intruder's activities. This graphical information display also may assist operators in determining the appropriate type of immediate action that should be taken to protect the network (such as shutting down the network connection to some network devices). In one embodiment, a historical graph 907 provides a graphical representation of the overall, time-averaged threat level (shown as line 919) facing the network to assist security operators conducting damage control and risk analysis. In another embodiment, the graphical display of security data may assist network security personnel in determining how to harden the network, such as hardening particular network devices, re-enforcing tougher user password policies, or implementing more network security measurement on certain network segments.

The operation and advantages of an embodiment of the present system may be appreciated by way of an example scenario of a particular attack and the appropriate system response. This scenario is presented by way of example but not by way of limitation. Referring to FIG. 7, when an attacker accesses the network, one or more sensor units (i.e., one or more of a deception unit, a notification unit, an interception unit, or a detection unit) monitoring the network communications identifies the suspicious activity of the attacker, step 701. The sensor unit identifying the attacker captures data on the attacker's activities, step 703. This sensor unit compares the attacker's activities against a Boolean logic table to determine whether the particular activities should be reported, step 705. If one or more of the attacker's activities matches an entry in the Boolean logic table indicating a report should not be made, the sensor unit continues to capture the intruder's activities, step 707 (negative determination). However, if the attacker's activities match a Boolean logic table entry indicating that a report needs to be made, the sensor unit packages the data on the attacker's activities into a message which is sent via the network using an encrypted message protocol, step 709. The attacker activity data message is transmitted to the receiving unit, step 711, which unpacks and decrypts the message, step 713. The receiving unit compares the attacker activities data against a Boolean table to determine whether the information should be communicated to security system operating personnel, step 715. In making this determination, the receiving unit may take into account the existing overall threat level facing the system, such that each attacker's activity may be evaluated using a Boolean table and the overall threat level facing the system. If the receiving unit determines that the network security system operator should be notified, the receiving unit sends out a notification using one or more of an electronic mail message, a message sent to a pager, and/or a phone call to the operator, step 717. The receiving unit also sends the attacker activity data to the DBMS unit where it is stored, step 719. If the receiving unit determines that network security system operators need not be notified, the receiving unit sends the attacker activity data directly to the DBMS unit for storage, step 719. In this scenario example, the network system responds to an attacker's activities by notifying the operators on duty who then may intervene to protect the network and/or investigate the attack.

The operation and advantages of another embodiment of the present system may be appreciated by way of a second example scenario wherein the network security system presents a virtual network to the attacker. Referring to FIG. 8, when an attacker probes the network using a DNS query, step 801, a network security DNS deception unit captures this query, step 803. The deception unit compares the attacker's query against a Boolean logic table to determine whether this query is allowed, steps 805, 807. If the check against the Boolean logic table indicates the query is allowed, the deception unit takes no action but continues to monitor DNS queries, step 807. However, if the DNS query is determined to be not allowed, the network security system responds by returning deceptive IP address data to the attacker, step 809. This deceptive IP address data redirects the attacker to a security system router deception unit and/or to a security system firewall deception unit, step 809. The security system router deception unit then responds to all further queries from the attacker by simulating a virtual network, including simulated host computers and simulated sub-networks, step 811. Thus redirected, the attacker may remain deceived while probing and accessing computers, sub-networks and files that do not in fact exist, while the security system gathers information on the attacker and network security personnel gain time to secure the real network from the attacker. This example scenario demonstrates how the network security system may use deception to respond to neutralize an attack without denying network access to legitimate users or risking loss of valuable information.

One of skill in the art would recognize that the above system describes the typical components of computer systems connected to an electronic network. It should be appreciated that many other similar configurations are within the abilities of one skilled in the art and all of these configurations could be used with the method of the present invention. Furthermore, it should be recognized that the computer system and network disclosed herein can be programmed and configured, by one skilled in the art, to implement the method steps discussed further herein. It would also be recognized by one of skill in the art that the various components that are used to implement the present invention may be comprised of software, hardware, or a combination thereof.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined be the claims appended hereto, and their equivalents.

What is claimed is:

1. A method for providing security on a computer-network, comprising the steps of:
providing a deception to a network intruder on the computer-network;
monitoring a response of the network intruder to the deception;
detecting the network intruder based upon the response of the network intruder to the deception;
collecting data regarding the network intruder; and
acting on the data regarding the network intruder to protect the computer-network.

2. The method as defined in claim 1, wherein the computer-network is connected to a public network and the deception is accessible via the public network.

3. The method as defined in claim 1, wherein the step of providing a deception the deception is accomplished by emulating an operating system, and wherein the monitoring step monitors attempts by the network intruder to access the emulated operating system.

4. The method as defined in claim 1, wherein the step of providing a deception the deception is accomplished by employing a deceptive machine designation, and wherein the monitoring step monitors attempts by the network intruder to address the deceptive machine designation.

5. The method as defined in claim 1, wherein the step of providing a deception the deception is accomplished by emulating normally protected network processes, and wherein the monitoring step monitors attempts by the network intruder to access the emulated normally protected network processes.

6. The method as defined in claim 1, wherein the step of providing a deception the deception is accomplished by storing deceptive data files with file names selected so as to attract a network intruder, and wherein the monitoring step monitors attempts by the network intruder to access the deceptive data files.

7. The method as defined in claim 1, wherein the step of providing the deception is accomplished by emulating network equipment or network servers, and wherein the monitoring step monitors attempts by the network intruder to access the emulated network equipment or network servers.

8. The method as defined in claim 7, wherein the emulated network equipment includes at least one selected from the group of network routers, firewalls, Virtual Private Network gateways, and switches.

9. The method as defined in claim 7, wherein the emulated network servers includes at least one selected from the group of Emulating DNS, Intrusion Detection Systems, and Remote Access Server.

10. The method as defined in claim 1, wherein the step of acting on the data regarding the network intruder comprises redirecting the network intruder away from the computer-network.

11. The method as defined in claim 1, wherein the step of acting on the data regarding the network intruder comprises shutting down part or all of the computer-network.

12. The method as defined in claim 1, wherein the step of acting on the data regarding the network intruder comprises informing an operator of the presence of the network intruder via a message.

13. The method as defined in claim 12, wherein the message to the operator is delivered by one or more of the following: a pager message, a telephone call, an e-mail message, an audio alarm and a visual display on a computer monitor.

14. The method as defined in claim 1, wherein the step of acting on the data regarding the network intruder comprises directing a reconnaissance unit on the public web to gather information on the network intruder.

15. The method as defined in claim 1, wherein the step of acting on the data regarding the network intruder comprises storing the data regarding the network intruder in a computer database for later analysis.

16. The method as defined in claim 1, wherein the step of acting on the data regarding the network intruder comprises displaying for an operator the network intruder's actions.

17. The method as defined in claim 1, further comprising the steps of:
intercepting disallowed network activities by the network intruder; and
acting on the intercepted disallowed network activities to protect the computer-network.

18. The method as defined in claim 1, wherein the detecting step comprises detecting a network intruder with a detection unit connected to the computer-network, the detection unit lacking an assigned internet-protocol address.

19. The method as defined in claim 1, further comprising the steps of displaying actions of the network intruder to allow an operator to view the network intruder's actions in real time and provide a direct communication mechanism between the system operator and the intruder.

20. The method as defined in claim 2, further comprising the step of providing data regarding the network intruder to a receiving unit using encrypted protocol data.

21. A method for detecting an intruder on a computer-network with access to a public network comprising the step of:
deceiving the intruder regarding the function, designation or data contents of a deception unit;
gathering data on the intruder as the intruder attempts to access the function, designation or data contents of the deception unit; and
outputting the data on the intruder to a receiving unit.

22. A method for protecting a computer-network once an intruder has been detected, comprising the steps of:
deceiving the intruder regarding the function, designation or data contents of a deception unit;
permitting the intruder to access the deceptive function, designation or data contents of the deception unit; and
gathering data on the intruder as the intruder accesses the deceptive function, designation or data contents of the deception unit.

23. A method of protecting a computer-network once an intruder has been detected according to claim 20, further comprising the step of redirecting the intruder away from the computer-network.

24. A method of protecting a computer-network once an intruder has been detected according to claim 20, further comprising the step of shutting down all or part of the computer-network.

25. A method of protecting a computer-network once an intruder has been detected according to claim 20, further comprising the step of displaying actions of the network intruder on a watching unit to allow an operator to view the network intruder's actions in real time.

26. A method of protecting a computer-network once an intruder has been detected according to claim 20, further comprising the step of performing reconnaissance on the network intruder using a computer on a public network outside the computer-network.

27. A system for protecting a computer-network connected to a public network from network intruders, comprising:
a management unit;
a sub-network connected to the management unit, the sub-network being separate from the protected computer-network and configured to communicate commands and data to and from the management unit;
a deception unit coupled to the management unit by the sub-network and accessible from the public network;
an interception unit coupled to the computer-network and coupled to the management unit by the sub-network;
a database management unit coupled to the protected computer-network and configured to store data regarding network intruders;
a receiver unit coupled to the management unit by the sub-network and configured to receive data from any one or all of the deception unit, interception unit, and notification unit, and communicate received data to the database management unit for storage; and
a reconnaissance unit coupled to the public network outside the computer-network and coupled to the management unit by the sub-network.

28. The security system according to claim 22, wherein the deception unit runs software stored on read only memory.

29. The security system according to claim 22, further comprising a watching unit coupled to the database management unit and configured to display activities of the network intruder.

30. The security system according to claim 22, wherein the management unit communicates with at least one of the deception unit, notification unit, intercept unit, detection unit, receiving unit, and reconnaissance unit using encrypted protocol data.

31. The security system according to claim 22, further comprising notification unit software stored on a data storage system on a computer coupled to the computer-network, the notification unit software being capable of monitoring activities on the computer to detect suspicious or unauthorized uses of the computer or the computer-network and providing an output to the receiving unit comprising data on the suspicious or unauthorized uses of the computer or the computer-network.

32. A security system for protecting a computer-network connected to a public network from intruders, comprising:
means for deceiving intruders as to the function, designation or content of a machine and providing an output of information regarding intruders' interactions with the means for deceiving, the means for deceiving being coupled to the computer-network and accessible by the public network;
means for detecting intruders based upon information provided in the output of the means for deceiving intruders, the means for detecting intruders being coupled to the computer network and configured to provide an output of data regarding detected intruders;
means for receiving the output of data regarding detected intruders provided by the means for detecting intruders;
means for storing data coupled to the means for receiving the output of data regarding detected intruders; and
means for managing the security system coupled to each of the means for deceiving intruders, detecting intruders, receiving the output of data and storing data.

33. The security system according to claim 32, further comprising:
means for intercepting disallowed network activities by intruders and providing information on the intercepted disallowed activities as an output to the means for receiving the output of data; and
means for monitoring activities on a computer for evidence of intruders and providing the evidence of intruders as an output to the means for receiving output of data.

34. The security system according to claim 32, further comprising:
reconnaissance means for obtaining information on detected intruders, the reconnaissance means being connected to the public network outside the computer-network and coupled to the means for managing the security system.

35. A computer readable data storage medium having program code recorded thereon for the automated detection of a network intruder on a computer-network connected to a public network, the program code comprising:
a first program code that masquerades as a device or network function which the network intruder is likely to seek out, detects the network intruder by monitoring attempts to access the masqueraded device or network function, gathers information on the network intruder and outputs the information on the network intruder;
a second program code that receives the outputted information on the network intruder, and acts upon the outputted information on the network intruder by issuing commands to protect the computer-network; and
a third program code that receives and executes the commands from the second program code.

36. The computer readable data storage medium according to claim 35, wherein the third program code directs the network intruder away from the computer-network.

37. The computer readable data storage medium according to claim 35, wherein the program code executes a shutdown of all or part of the computer-network.

38. The computer readable data storage medium according to claim 35, wherein the program code further comprises:
a fourth program code that monitors activities on a computer for activities that indicate a network intruder, collects data on the activities that indicate a network intruder and provides the collected data to the second program code.

39. The computer readable data storage medium according to claim 35, wherein the program code further comprises:
a fourth program code that manages the operations of the first, second and third program codes.

40. The computer readable data storage medium according to claim 35, wherein the program code further comprises:
a fifth program code under the management of the fourth program code that collects data on the network intruder by monitoring the network intruder message packets and querying the network intruder via the public network.

41. A system for providing security on a computer-network, comprising:
a management component for managing the system;
a deception component for deceiving network intruders and providing an output comprising data on actions taken by the network intruder, the deception component being coupled to the management unit and to the computer network;
a receiving component for receiving the output from the deception component and providing an output of data, the receiving component being coupled to the deception component, and the management component; and
a data collection component for receiving the data output from the receiving component, storing data and providing stored data to the receiving component and/or the management component, the data collection component being coupled to the receiving unit and to the management component.

42. The system according to claim 41, further comprising a watching component for displaying information on the actions of the network intruder, the watching component being coupled to the data collection component and to the management component.

43. The system according to claim 41, further comprising an interception component coupled to the computer-network for intercepting a disallowed use of the computer-network and providing an output to the receiver component comprising data on the disallowed use of the computer-network.

44. The system according to claim 41, further comprising a detection component coupled to the computer-network for detecting disallowed use of the computer-network and providing an output to the receiver component comprising data on the disallowed use of the computer-network, the detecting component lacking an internet protocol address.

45. The system according to claim 41, further comprising a notification component installed on a computer coupled to the computer-network for monitoring the computer for suspicious and disallowed activities and providing an output to the receiver component comprising data regarding suspicious and disallowed activities.

46. A method for providing security for a computer network against network intruders, comprising the steps of:
monitoring the network for intruder activities;
calculating a threat level for the computer network based on the monitored intruder activities; and
acting on the calculated threat level to protect the computer network.

47. The method according to claim 46, wherein the step of calculating a threat level for the computer network calculates the threat level for the computer network at any given time by weight averaging attacks over a predetermined time window.

48. The method according to claim 46, wherein the step of calculating a threat level for the computer network comprises the further steps of breaking intruder activities into multiple network communication layers, converting the multiple layers into Boolean values and applying the Boolean values in a Boolean logic algorithm to yield an overall threat level.

49. The method according to claim 46, further comprising the step of emulating an entirely virtual network with its own emulated routers and hosts, wherein a deception router unit is assigned to the virtual network to provide deception to network intruders.

50. The method according to claim 46, further comprising the step of providing a secure communication protocol to permit secure communications among all system components.

51. A method for providing security for a computer network against network intruders, comprising the steps of:
monitoring the computer network for an intruder's activities;
providing a visual display of the intruder's activities that permits interaction between the network security operator and the intruder; and
providing a graphical display of the intruder's current activities and historical activities collected over a period of time.

52. The method according to claim 51 further comprises the steps of displaying the intruder's activities as indicia on a radar screen positioned on different sectors of a radar screen having a center and sectors corresponding to different network segments, wherein the proximity of the indicia to the center correlates to a level of threat facing the system.

53. The method according to claim 51, wherein the visual display of the intruder's activities facilitates interactions between security personnel and an attacker.

54. The method according to claim 51 further comprising the steps of an operator conducting a damage assessment using the visual display of the intruders activities; and the operator taking an action to protect the network.
